(19) United States
(12) Patent Application Publication
(10) Pub. No.: US 2006/0192674 A1
(43) Pub. Date: Aug. 31, 2006

(54) Matched RFID enabled illuminating jewelry/personal articles

(76) Inventor: George Roberta, Mount Kisco, NY (US)

Correspondence Address: Mr. George Roberta, 229 McLain Street, Mount Kisco, NY, 10549, US

(21) Appl. No.: 11/348,004

(22) Filed: Feb. 6, 2006

Related U.S. Application Data
(60) Provisional application No. 60/652,525, filed on Feb. 11, 2005.

(51) Int. Cl. G08B 1/08; G08B 13/14; G08B 23/00; G08B 21/00

(52) U.S. Cl. 340/539.23; 340/618; 340/686.6; 340/573.1; 340/572.1

(57) ABSTRACT

Jewelry/personal articles in the form of sets of items which may be sold in pairs or groups, each article of the group being provided with the RFID circuitry unique to that pair or group and an electrical display which will illuminate when two or more of the items of the group are in proximity to each other, but not requiring one to be in physical contact with another. In one embodiment the personal article comprises a heart necklace and a circular pendant, each provided with an electrical display such as a lamp and a normally open battery powered electrical circuit interconnected with the electrical display and uniquely coded RFID containing a tag and reader. Operation of the electrical display is initiated by bringing the two articles within proximity of each other and the uniquely coded RFID circuitry of the one item recognizes the matched uniquely coded RFID circuitry of another item of the same pair or group.

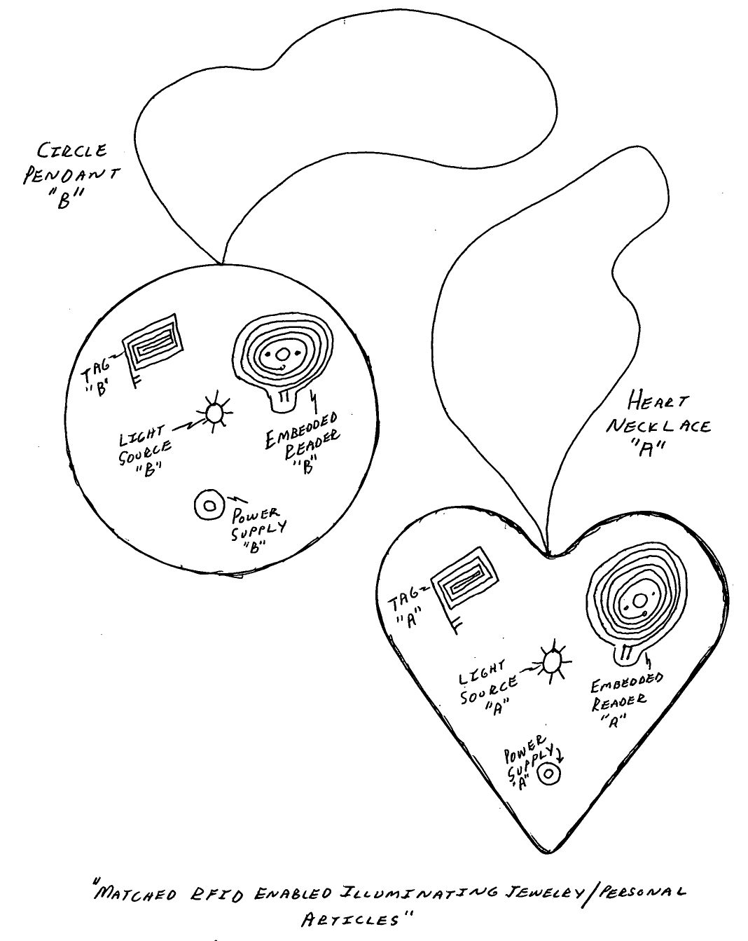

### CROSS-REFERENCE TO RELATED APPLICATIONS

Provisional Application No. 60/652,525, filed Feb. 11, 2005 by George Roberta

Widow & Widower Ring

Novelty Jewelry

Split Friendship Hearts

Scented Bracelet Kit (Friendship Bracelets)

Wireless Communication Apparatus in the Form of a Necklace

Radio Frequency Identification Transponder having Integrated Antenna

### STATEMENT REGARDING FEDERALLY SPONSORED RESEARCH

Not applicable.

A personal article includes the intelligent coded RFID circuitry and light source to identify, through illumination, when it is in the proximity of another personal article with similar intelligent coded RFID circuitry and light source thus enabling individuals wearing/carrying said personal articles to uniquely identify with each other through the illumination.

### BACKGROUND OF THE INVENTION

Personal articles, such as jewelry, hats and handbags, have routinely been decorated and configured in virtually every way imaginable. It is well established that lighted personal articles such as illuminated earrings, lighted pendants and lighting devices for jewelry have been attempted, designed and patented, each having their own design and uniqueness. Furthermore, it is well known, friends or a specified group could indicate their bond with each other by wearing matching generic items, such as his and her clothing (ie same color, same slogan and/or same design), matched “half-hearts” and rings, team hats, etc. These generic items did not contain any technology that would uniquely identify one article with and only with, one other personal article. Previously, each item identified with ALL the other “paired” items produced.

The present invention concerns adding coded RFID technology and an illumination capability to jewelry/personal articles, and more particularly, relates to jewelry/personal articles having the coded RFID electronics and a light source incorporated in the article for illuminating the article when and only when it comes within proximity of its electronically “matched” personal article, but NOT having to contact it or look similar to it. This invention allows for the identification only when in the presence of its unique electronically matched counterpart and can be accomplished using completely different articles, such as a hat and pendant, by using illumination to uniquely identify the couple or group.

### BRIEF SUMMARY OF THE INVENTION

This invention relates to interactive personal articles, such as jewelry, clothing accessories, fashion items and ornaments, having coded RFID circuitry which identifies and illuminates when one personal article with unique coding comes within close proximity to another personal article which is part of the same uniquely coded group. More particularly, it is an object of the present invention to provide personal articles comprising a minimum of a first and second item, each provided with an electrical display and a normally open electrical circuit interconnected with the electrical display and a battery or other source of electrical current. Operation of the electrical display is initiated by bringing the two articles within proximity of each other and the matched coded RFID recognizing another of the matched pair or group. This will allow individuals or groups who desire to be identified with each other to be identified uniquely and only when in the presence of another member of the pair or group. The couple or group is identified not through complementing words, colors or visually similar articles but rather through illumination to be emitted from any type of personal article matched to any other personal article containing the unique RFID circuitry associated with said group and made part of the personal articles.

### DETAILED DESCRIPTION OF THE INVENTION

Personal articles such as jewelry, hats and handbags will be made to contain the necessary RFID circuitry for communicating and identifying another personal article within the unique pair or group. Each personal article within the group includes a light source which illuminates when, and only when, coming within close proximity of a coded personal article from the same uniquely coded group. This would allow for individuals wearing dissimilar personal articles, via illumination, to be identified with one another without having any physical contact or visually matched article.

More specifically, the present invention discloses a personal article such as jewelry, hats handbags or sneakers having RFID circuits including a power source, transceiver (tag reader), transducer (identifying tag) and light source therein capable of mutual wireless communication and illumination. Personal articles fabricated with the RFID circuits allow persons with matched coding to have a portion of or all of the article illuminate when personal articles of a unique group, via radio frequency, detect, without physical contact, the presence of each other. Such a personal article is applicable for use with various types of groups, teams and couples who want to be visually identified uniquely with each other.

For the simple case, the invention will consist of two similarly coded RFID enabled personal articles, which contain a light source and necessary electronics to illuminate, when in proximity of the other. Each of the two coded electronic personal articles include RFID circuitry for communicating with, and only with, the other similarly coded electronic personal article, the RFID circuitry communicating at least the information identifying that personal article as the matching personal article in that pair and no other.

In particular, the first personal article includes coded electronic RFID circuitry for communicating with a second similarly coded electronic RFID circuit of a second personal article, the circuitry communicating at least the information identifying that personal article as an object in the pair. Each article of the unique pair includes a light source connected to the RFID circuitry which closes the normally open circuit and illuminates when coming within the proximity of and identifying the similarly coded personal article in the pair.

In the more complex form it is envisioned that either 1) all, 2) several, or 3) one matched coded personal article(s) will illuminate when coming within proximity of one or more other matched electronically coded personal articles resulting in one or more personal articles of the uniquely matched coded group within proximity of each other illuminating.

### DRAWING

In the attached diagram indicated a Heart Necklace is matched to a Circular Pendant. When the Heart Necklace “A” and Circular Pendant “B” come within proximity of one another the Embedded Reader “A” of the Heart Necklace reads Tag “B” of the Circular Pendant. Embedded Reader “A” upon determining Tag “B” is a member of the unique pair activates Light Source “A”, which is energized by Power Supply “A”. Likewise, Embedded Reader “B” of the Circular Pendant reads Tag “A” of the Heart Necklace. Embedded Reader “B” upon determining Tag “A” is a member of the unique pair activates Light Source “B”, which is energized by Power Supply “B”. When the distance between Reader “A” and Tag “B” becomes too great for Reader “A” to detect Tag “B” Light Source “A” will no longer be energized or illuminated. Likewise, when the distance between Reader “B” and Tag “A” becomes too great for Reader “B” to detect Tag “A” Light Source “B” will no longer be energized or illuminated.

Identification circuitry can be accomplished using technology similar to those listed below:

U.S. Pat. No. 6,827,281 describes a method of encoding using a phase modulation of selected finger pairs on each SAW device which in effect places a unique identifier on the tag or sensor's returned impulse response. An algorithm is then used to separate out each unique identifier and reconstruct the unique identification number of each tag or sensor.

U.S. Pat. No. 6,034,603 describes a data transmission system which includes a reader transceiver and one or more semiconductor-based tag transceivers. The reader transmits an activation signal to a semiconductor-based tag. The tag selectively transmits a response signal to the reader at a specific time determined by a detected level of communications channel activity.

U.S. Pat. No. 6,150,921 describes a system for tracking mobile tags. Cell controllers with multiple antenna modules generate a carrier signal which is received by the tags. Tags shift the frequency of the carrier signal, modulate an identification code onto it, and transmit the resulting tag signal at randomized intervals.

U.S. Pat. No. 6,377,203 describes a method for simultaneously reading a serial number and/or other information from multiple colliding RF signals from RF identification tags requires minimal additional logic in the semiconductor-based tag's processor and provides for a powerful and rapid sorting and identification scheme. This technique employs a primary communication channel and multiple secondary channels.

U.S. Pat. No. 6,392,544 describes a radio frequency identification reader which includes a plurality of antenna elements that are spaced to define active areas. A matrix switch flexibly connects the plurality of antenna elements to an exciter circuit. Independent switches are selectively switched such that an electric field is generated between at least

What is claimed is:

1) Personal articles comprising:
a first item to be worn or carried provided with an intelligent and uniquely coded RFID, light and power source;
a second item to be worn or carried provided with an intelligent and similarly coded RFID and power source.

2) A method for individuals to identify uniquely with each other only while in the presence of other group members.

3) A method for individuals to identify uniquely with each other, via illumination, with different unmatched personal articles.

4) An ability for two, or up to, an unlimited number of similarly coded personal articles to be part of the group.

5) A method of identification unique to only one couple or group.
